(19) United States
(12) Patent Application Publication
(10) Pub. No.: US 2026/0292769 A1
(43) Pub. Date: Sep. 24, 2026

(54) Method and Apparatus for Location Service

(71) Applicant: Telefonaktiebolaget LM Ericsson (publ), Stockholm (SE)

(72) Inventors: Igor Pastushok, Kirkkonummi (FI); Wenliang Xu, Shanghai (CN)

(21) Appl. No.: 19/473,668

(22) PCT Filed: Apr. 8, 2024
(86) PCT No.: PCT/CN2024/086521

§ 371 Date: Oct. 8, 2025

(30) Foreign Application Priority Data
Apr. 10, 2023 (WO) PCT/CN2023/087297

(51) Int. Cl. H04W 64/00; H04W 4/021

(52) U.S. Cl. CPC H04W 64/00; H04W 4/021

(57) ABSTRACT

Embodiments of the present disclosure provide methods and apparatuses for location service. A method performed by a location management server may comprise receiving a first location reporting trigger for a geographical area from a server. The first location reporting trigger comprises at least one event triggered location reporting criteria and/or at least one time triggered location reporting criteria. The method may further comprise sending a location information report to the server based on the at least one event triggered location reporting criteria and/or the at least one time triggered location reporting criteria.

### TECHNICAL FIELD

The non-limiting and exemplary embodiments of the present disclosure generally relate to the technical field of communications, and specifically to methods and apparatuses for location service.

### BACKGROUND

This section introduces aspects that may facilitate a better understanding of the disclosure. Accordingly, the statements of this section are to be read in this light and are not to be understood as admissions about what is in the prior art or what is not in the prior art.

3rd Generation Partnership Project (3GPP) Technical Specification (TS) 23.434 V18.4.0, the disclosure of which is incorporated by reference herein in its entirety, has specified the functional architecture for service enabler architecture layer (SEAL) and the procedures, information flows and Application Programming Interfaces (APIs) for each service within SEAL in order to support vertical applications over the 3GPP system. SEAL is applicable to vertical applications using Evolved Universal Terrestrial Radio Access Network (E-UTRAN) or new radio (NR) access based on the Evolved Packet Core (EPC) or fifth generation system (5GS) architecture as defined in 3GPP TS 23.401 V18.1.0 and 3GPP TS 23.501 V18.0.0, the disclosures of which are incorporated by reference herein in its entirety. 3GPP TS 23.434 V18.4.0 specifies application plane and signaling plane entities for application-enabling services (e.g. group management, configuration management, location management, identity/key management, network resource management) that can be reused across vertical applications. SEAL also specifies the northbound APIs for its individual services to enable flexible integration with vertical applications.

FIG. 1a illustrates a generic on-network functional model for location management, which is same as FIG. 9.2.2-1 of 3GPP TS 23.434 V18.4.0.

The location management (LM) client communicates with the location management server over the LM Universal User-network interface (LM-UU) reference point. The location management client provides the support for location management functions to the Vertical Application Layer (VAL) client(s) over LM client (LM-C) reference point. The VAL server(s) communicate with the location management server over the LM server (LM-S) reference point. The VAL client communicates with the VAL server over the VAL-UU reference point which is outside the scope of this document.

The location management server communicates with the Service Capability Exposure Function (SCEF) via T8 reference point to obtain location information from the underlying 3GPP network system. The location management server obtains location information from the NEF via N33 reference point by mechanism defined in clause 5.2.6.2 of 3GPP TS 23.502 V18.0.0, the disclosure of which is incorporated by reference herein in its entirety. The location management server may obtain location information from the Gateway Mobile Location Centre (GMLC) via Le reference point defined in clause 4.4.1 of 3GPP TS 23.273 V18.1.0, the disclosure of which is incorporated by reference herein in its entirety. The location management server may optionally obtains location information from the 3rd party (3P) location server via LM-3P reference point.

When the fused location function is present, the location management server may use the location information from multiple sources to determine a more accurate UE location. The fused location function may select one or more location sources and location methods based on the requested location quality of service (QoS) which obtained from the location management server.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

There are some problems for the existing solution of location service.

The VAL server is not able to provide any location reporting triggering criteria for the SEAL location management client to the SEAL location management server via LM-S reference point, which is not specified in 3GPP TS 29.549 V18.1.0.

3GPP TS 29.549 V18.1.0, the disclosures of which are incorporated by reference herein in its entirety, defines the protocol aspects of the SEAL layer, including the location reporting functionality defined in clauses 9.3.5 and 9.3.2.4 of 3GPP TS 23.434 V18.4.0. The current implementation defined in clause 7.1.1.4.2.2 of 3GPP TS 29.549 V18.1.0 is not aligned with clause 9.3.2.4 of 3GPP TS 23.434 V18.4.0, i.e., the location reporting triggering criteria is missed in 3GPP TS 29.549 V18.1.0. Thus, the VAL service area support and the related triggering criteria shall be specified in 3GPP TS 29.549 V18.1.0.

The exiting solution cannot allow tracking a user equipment (UE) position inside and/or outside a given location (or geographical area or service area). For example, the solution in 3GPP TS 29.572 V18.1.0 (see Table 6.1.6.3.14-1: Enumeration: LdrType), the disclosure of which is incorporated by reference herein in its entirety, only allows to track UEs entering/leaving the given location or area. For UE being inside an area, the existing solution does not explain further difference between “ENTERING_INTO_AREA” and “BEING_INSIDE_AREA”.

TABLE 6.1.6.3.14-1
Enumeration LdrType

| Enumeration value | Description |
|---|---|
| “UE_AVAILABLE” | UE available event |
| “PERIODIC” | Periodic event |
| “ENTERING_INTO_AREA” | Entering area event |
| “LEAVING_FROM_AREA” | Leaving area event |
| “BEING_INSIDE_AREA” | Being inside area event |
| “MOTION” | Motion event |

The existing solution cannot support flexible periodic and/or event triggered location reporting triggers with finer granularity. For example, the existing solution cannot support sending location reporting if a UE stays inside or outside the given location longer than the given time period.

The existing solution cannot support the tracking (a sequence of location reports) when UE moves inside or outside a given location with a given granularity based on a provided location change condition (e.g., the cell/base station etc. change or Global Positioning System (GPS) coordinate change).

To overcome or mitigate at least one of above mentioned problems or other problems, an improved solution for location service may be desirable.

In a first aspect of the disclosure, there is provided a method performed by a location management server. The method may comprise receiving a first location reporting trigger for a geographical area from a server. The first location reporting trigger may comprise at least one event triggered location reporting criteria and/or at least one time triggered location reporting criteria. The method may further comprise sending a location information report to the server based on the at least one event triggered location reporting criteria and/or the at least one time triggered location reporting criteria.

In an embodiment, the method may further comprise initiating a location reporting procedure for obtaining location information of a user equipment (UE) based on the at least one event triggered location reporting criteria and/or the at least one time triggered location reporting criteria. The method may further comprise updating an old location reporting trigger for the geographical area based on the at least one event triggered location reporting criteria and/or the at least one time triggered location reporting criteria.

In an embodiment, the initiating the location reporting procedure for obtaining location information of the UE based on the at least one event triggered location reporting criteria and/or the at least one time triggered location reporting criteria may comprise deciding to immediately initiate request location information from the location management client based on the at least one event triggered location reporting criteria and/or the at least one time triggered location reporting criteria, sending a location information request to the location management client, and receiving a location information report from the location management client.

In an embodiment, the initiating the location reporting procedure for obtaining location information of the UE based on the at least one event triggered location reporting criteria and/or the at least one time triggered location reporting criteria may comprise receiving a location reporting configuration request from the location management client, generating an initial location reporting event triggers configuration or a subsequent updated location reporting event triggers configuration based on the at least one event triggered location reporting criteria and/or the at least one time triggered location reporting criteria, sending a location reporting configuration response comprising the initial location reporting event triggers configuration or the subsequent updated location reporting event triggers configuration to the location management client, and receiving a location information report from the location management client.

In an embodiment, the initiating the location reporting procedure for obtaining location information of the UE based on the at least one event triggered location reporting criteria and/or the at least one time triggered location reporting criteria may comprise generating an initial location reporting event triggers configuration or a subsequent updated location reporting event triggers configuration based on the at least one event triggered location reporting criteria and/or the at least one time triggered location reporting criteria, sending the initial location reporting event triggers configuration or the subsequent updated location reporting event triggers configuration to the location management client, and receiving a location information report from the location management client.

In an embodiment, the at least one event triggered location reporting criteria may comprise at least one of a location reporting occurs when a UE moves inside a given location, a location reporting occurs when a UE moves outside a given location, a location reporting occurs when a UE stays in a given location longer than a given period of time, or a location reporting occurs when a UE stays out of a given location longer than a given period of time.

In an embodiment, a movement of a UE may comprise at least one of a cell change of the UE, a radio access network node change of the UE, a tracking area change of the UE, a routing area change of the UE, an access network change of wireless local area network of the UE, a change of a civic address in which the UE is located, or a positioning system coordinate change of the UE.

In an embodiment, the at least one time triggered location reporting criteria may comprise at least one of a location reporting occurs with a given periodicity when a UE is inside a given location, or a location reporting occurs with a given periodicity when a UE is outside a given location.

In an embodiment, the first location reporting trigger for the geographical area may be received from the server in a location information subscription request or a location area monitoring subscription request or a location area monitoring subscription modify request or during a vertical application layer server-triggered location reporting procedure.

In an embodiment, the server may comprise a vertical application layer server.

In an embodiment, the location information report may comprise location information of a UE.

In an embodiment, the method may further comprise sending information indicating whether the location management server supports vertical application layer service area functionality to the server. The method may further comprise receiving information indicating whether the server supports vertical application layer service area functionality from the server.

In a second aspect of the disclosure, there is provided a method performed by a server. The method may comprise sending a first location reporting trigger for a geographical area to a location management server. The first location reporting trigger may comprise at least one event triggered location reporting criteria and/or at least one time triggered location reporting criteria. The method may further comprise receiving a location information report from the location management server.

In an embodiment, the at least one event triggered location reporting criteria may comprise at least one of a location reporting occurs when a user equipment, UE, moves inside a given location, a location reporting occurs when a UE moves outside a given location, a location reporting occurs when a UE stays in a given location longer than a given period of time, or a location reporting occurs when a UE stays out of a given location longer than a given period of time.

In an embodiment, a movement of a UE may comprise at least one of a cell change of the UE, a radio access network node change of the UE, a tracking area change of the UE, a routing area change of the UE, an access network change of wireless local area network of the UE, a change of a civic address in which the UE is located, or a positioning system coordinate change of the UE.

In an embodiment, the at least one time triggered location reporting criteria may comprise at least one of a location reporting occurs with a given periodicity when a UE is inside a given location, or a location reporting occurs with a given periodicity when a UE is outside a given location.

In an embodiment, the first location reporting trigger for the geographical area may be sent to the location management server in a location information subscription request or a location area monitoring subscription request or a location area monitoring subscription modify request or during a vertical application layer server-triggered location reporting procedure.

In an embodiment, the server may comprise a vertical application layer server.

In an embodiment, the first location reporting trigger may be used to activate a location reporting procedure for obtaining location information of a UE, or update an old location reporting trigger for the geographical area.

In an embodiment, the location information report may comprise location information of a UE.

In an embodiment, the method may further comprise receiving information indicating whether the location management server supports vertical application layer service area functionality from the location management server. The method may further comprise sending information indicating whether the server supports vertical application layer service area functionality to the location management server.

In a third aspect of the disclosure, there is provided a method performed by a location management client. The method may comprise receiving an initial location reporting event triggers configuration or a subsequent updated location reporting event triggers configuration from the location management server. The initial location reporting event triggers configuration or the subsequent updated location reporting event triggers configuration may be generated based on at least one event triggered location reporting criteria and/or at least one time triggered location reporting criteria for a geographical area. The method may further comprise storing the initial location reporting event triggers configuration or updating an old location reporting event triggers configuration based on the subsequent updated location reporting event triggers configuration. The method may further comprise sending a location information report to the location management server based on the initial location reporting event triggers configuration or the subsequent updated location reporting event triggers configuration.

In an embodiment, the method may further comprise sending a location reporting configuration request to a location management server. The method may further comprise receiving a location reporting configuration response from the location management server. The initial location reporting event triggers configuration or the subsequent updated location reporting event triggers configuration may be received from the location management server in the location reporting configuration response.

In an embodiment, the at least one event triggered location reporting criteria may comprise at least one of a location reporting occurs when a user equipment (UE) moves inside a given location, a location reporting occurs when a UE moves outside a given location, a location reporting occurs when a UE stays in a given location longer than a given period of time, or a location reporting occurs when a UE stays out of a given location longer than a given period of time.

In an embodiment, a movement of a UE may comprise at least one of a cell change of the UE, a radio access network node change of the UE, a tracking area change of the UE, a routing area change of the UE, an access network change of wireless local area network of the UE, a change of a civic address in which the UE is located, or a positioning system coordinate change of the UE.

In an embodiment, the at least one time triggered location reporting criteria may comprise at least one of a location reporting occurs with a given periodicity when a UE is inside a given location, or a location reporting occurs with a given periodicity when a UE is outside a given location.

In an embodiment, the location information report may comprise location information of a location management client.

In a fourth aspect of the disclosure, there is provided a location management server. The location management server may comprise a processor and a memory coupled to the processor. Said memory contains instructions executable by said processor. Said location management server is operative to receive a first location reporting trigger for a geographical area from a server. The first location reporting trigger may comprise at least one event triggered location reporting criteria and/or at least one time triggered location reporting criteria. Said location management server is further operative to send a location information report to the server based on the at least one event triggered location reporting criteria and/or the at least one time triggered location reporting criteria.

In a fifth aspect of the disclosure, there is provided a server. The server may comprise a processor and a memory coupled to the processor. Said memory contains instructions executable by said processor. Said server is operative to send a first location reporting trigger for a geographical area to a location management server. The first location reporting trigger may comprise at least one event triggered location reporting criteria and/or at least one time triggered location reporting criteria. Said server is further operative to receive a location information report from the location management server.

In a sixth aspect of the disclosure, there is provided a location management client. The location management client may comprise a processor and a memory coupled to the processor. Said memory contains instructions executable by said processor. Said location management client is operative to receive an initial location reporting event triggers configuration or a subsequent updated location reporting event triggers configuration from the location management server. The initial location reporting event triggers configuration or the subsequent updated location reporting event triggers configuration is generated based on at least one event triggered location reporting criteria and/or at least one time triggered location reporting criteria for a geographical area. Said location management client is further operative to store the initial location reporting event triggers configuration or updating an old location reporting event triggers configuration based on the subsequent updated location reporting event triggers configuration. Said location management client is further operative to send a location information report to the location management server based on the initial location reporting event triggers configuration or the subsequent updated location reporting event triggers configuration.

In a seventh aspect of the disclosure, there is provided a location management server. The location management server may comprise a first receiving module configured to receive a first location reporting trigger for a geographical area from a server. The first location reporting trigger may comprise at least one event triggered location reporting criteria and/or at least one time triggered location reporting criteria. The location management server may comprise a first sending module configured to send a location information report to the server based on the at least one event triggered location reporting criteria and/or the at least one time triggered location reporting criteria.

In an embodiment, the location management server may further comprise an initiating module configured to initiate a location reporting procedure for obtaining location information of a user equipment (UE) based on the at least one event triggered location reporting criteria and/or the at least one time triggered location reporting criteria.

In an embodiment, the location management server may further comprise an updating module configured to update an old location reporting trigger for the geographical area based on the at least one event triggered location reporting criteria and/or the at least one time triggered location reporting criteria.

In an embodiment, the location management server may further comprise a second sending module configured to send information indicating whether the location management server supports vertical application layer service area functionality to the server.

In an embodiment, the location management server may further comprise a second receiving module configured to receive information indicating whether the server supports vertical application layer service area functionality from the server.

In an eighth aspect of the disclosure, there is provided a server. The server may comprise a first sending module configured to send a first location reporting trigger for a geographical area to a location management server. The first location reporting trigger may comprise at least one event triggered location reporting criteria and/or at least one time triggered location reporting criteria. The server may further comprise a first receiving module configured to receive a location information report from the location management server.

In an embodiment, the server may comprise a second receiving module configured to receive information indicating whether the location management server supports vertical application layer service area functionality from the location management server.

In an embodiment, the server may comprise a second sending module configured to send information indicating whether the server supports vertical application layer service area functionality to the location management server.

In a ninth aspect of the disclosure, there is provided a location management client. The location management client may comprise a first receiving module configured to receive an initial location reporting event triggers configuration or a subsequent updated location reporting event triggers configuration from the location management server. The initial location reporting event triggers configuration or the subsequent updated location reporting event triggers configuration may be generated based on at least one event triggered location reporting criteria and/or at least one time triggered location reporting criteria for a geographical area. The location management client may further comprise a storing module configured to store the initial location reporting event triggers configuration or updating an old location reporting event triggers configuration based on the subsequent updated location reporting event triggers configuration. The location management client may further comprise a first sending module configured to send a location information report to the location management server based on the initial location reporting event triggers configuration or the subsequent updated location reporting event triggers configuration.

In an embodiment, the location management client may further comprise a second sending module configured to send a location reporting configuration request to a location management server.

In an embodiment, the location management client may further comprise a second receiving module configured to receive a location reporting configuration response from the location management server. The initial location reporting event triggers configuration or the subsequent updated location reporting event triggers configuration may be received from the location management server in the location reporting configuration response.

In a tenth aspect of the disclosure, there is provided a computer program product, comprising instructions which, when executed on at least one processor, cause the at least one processor to carry out any of the methods according to the first, second or third aspects of the disclosure.

In an eleventh aspect of the disclosure, there is provided a computer-readable storage medium storing instructions which, when executed by at least one processor, cause the at least one processor to carry out any of the method according to the first, second or third aspects of the disclosure.

Embodiments herein afford many advantages, of which a non-exhaustive list of examples follows. In some embodiments herein, the proposed solution can allow to track UE position inside and/or outside the given location. In some embodiments herein, the proposed solution can enable flexible periodic and/or event triggered location reporting triggers with finer granularity. In some embodiments herein, the tracking (a sequence of the location reports) may occur when UE moves inside/outside the given location with the given granularity based on the provided location change condition. In some embodiments herein, the UE position may be tracked based on the GPS coordinate changed event when UE moves outside the given location. In some embodiments herein, the proposed solution enables the flexible tracking of the UE position in 3GPP system. The embodiments herein are not limited to the features and advantages mentioned above. A person skilled in the art will recognize additional features and advantages upon reading the following detailed description.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1a illustrates a generic on-network functional model for location management;

FIG. 1b schematically shows a high level architecture in a 4G network;

FIG. 1c schematically shows a high level architecture in the fifth generation network according to an embodiment of the present disclosure;

FIG. 2a shows a flowchart of a method according to an embodiment of the present disclosure;

FIG. 2b shows a flowchart of a method according to another embodiment of the present disclosure;

FIG. 2c shows a flowchart of a method according to another embodiment of the present disclosure;

FIG. 2d shows a flowchart of a method according to another embodiment of the present disclosure;

FIG. 2e shows a flowchart of a method according to another embodiment of the present disclosure;

FIG. 2f shows a flowchart of a method according to another embodiment of the present disclosure;

FIG. 3 shows a flowchart of a method according to another embodiment of the present disclosure;

FIG. 4 shows a flowchart of a method according to another embodiment of the present disclosure;

FIG. 5 shows a flowchart of a method according to another embodiment of the present disclosure;

FIG. 6 shows a flowchart of a method according to another embodiment of the present disclosure;

FIG. 7 shows a flowchart of a high level procedure of client-triggered or VAL server-triggered location reporting according to another embodiment of the present disclosure;

FIG. 8a is a block diagram showing an apparatus suitable for practicing some embodiments of the disclosure;

FIG. 8b is a block diagram showing a location management server according to an embodiment of the disclosure;

FIG. 8c is a block diagram showing a server according to an embodiment of the disclosure;

FIG. 8d is a block diagram showing a location management client according to an embodiment of the disclosure;

FIG. 9 shows an example of a communication system according to an embodiment of the disclosure;

FIG. 10 shows a UE in accordance with some embodiments;

FIG. 11 shows a network node in accordance with some embodiments;

FIG. 12 is a block diagram of a host according to an embodiment of the disclosure;

FIG. 13 is a block diagram illustrating a virtualization environment in which functions implemented by some embodiments may be virtualized; and

FIG. 14 shows a communication diagram of a host communicating via a network node with a UE over a partially wireless connection according to an embodiment of the disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable communication standards such as new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by a standard organization such as 3GPP. For example, the communication protocols may comprise the first generation (1G), 2G, 3G, 4G, 4.5G, 5G, 6G communication protocols, and/or any other protocols either currently known or to be developed in the future.

The term “network device” or “network node” or “network function” refers to any suitable function which can be implemented in a network entity (physical or virtual) of a communication network. For example, the network function can be implemented either as a network element on a dedicated hardware, as a software instance running on a dedicated hardware, or as a virtualized function instantiated on an appropriate platform, e.g. on a cloud infrastructure. For example, the 5G system (5GS) may comprise a plurality of NFs such as AMF (Access and Mobility Management Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), NWDAF (network data analytics function), NSSF (Network Slice Selection Function), NSSAAF (Network Slice-Specific Authentication and Authorization Function), etc. For example, the 4G system (such as LTE (Long Term Evolution)) may include MME (Mobile Management Entity), HSS (home subscriber server), Policy and Charging Rules Function (PCRF), Packet Data Network Gateway (PGW), PGW control plane (PGW-C), Serving gateway (SGW), SGW control plane (SGW-C), E-UTRAN Node B (eNB), etc. In other embodiments, the network function may comprise different types of NFs for example depending on a specific network.

The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VOIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP (3rd Generation Partnership Project), such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and B” or “at least one of A or B” should be understood to mean “only A, only B, or both A and B.” The phrase “A and/or B” should be understood to mean “only A, only B, or both A and B”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

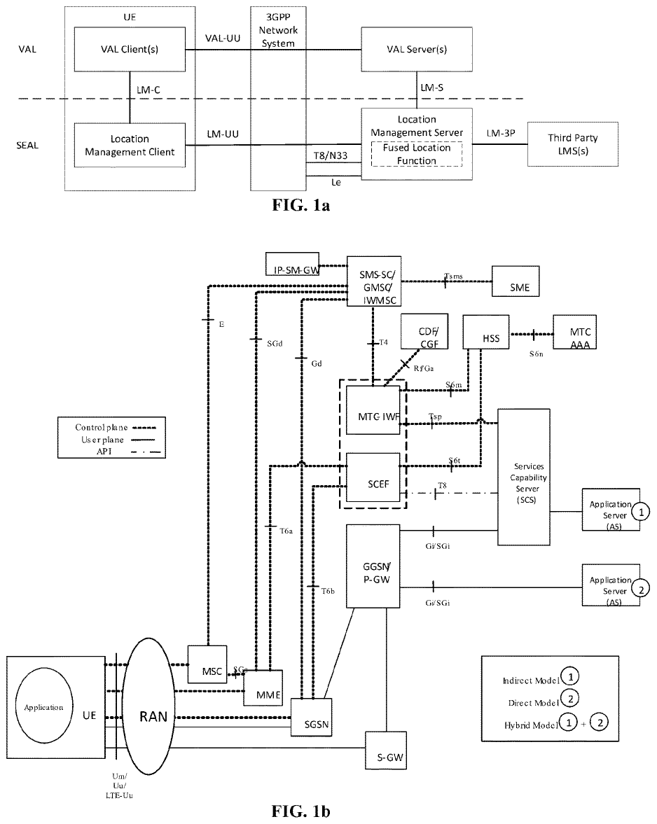

Although the subject matter described herein may be implemented in any appropriate type of system using any suitable components, the embodiments disclosed herein are described in relation to a communication system complied with the exemplary system architecture illustrated in FIGS. 1a, 1b and 1c. For simplicity, the system architecture of FIGS. 1a, 1b and 1c only depicts some exemplary elements. In practice, a communication system may further include any additional elements suitable to support communication between terminal devices or between a wireless device and another communication device, such as a landline telephone, a service provider, or any other network node or terminal device. The communication system may provide communication and various types of services to one or more terminal devices to facilitate the terminal devices' access to and/or use of the services provided by, or via, the communication system.

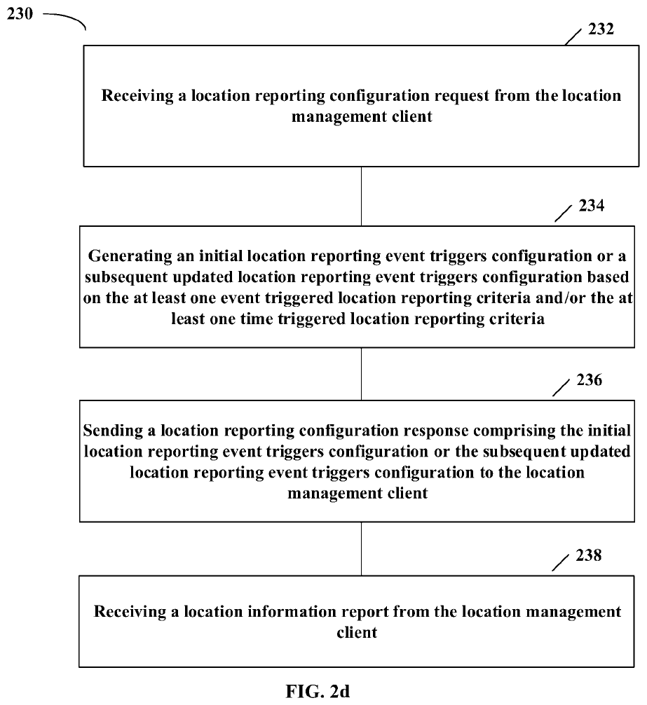

FIG. 1b schematically shows a high level architecture in a 4G network, which is same as FIG. 4.2-1a of 3GPP TS 23.682 V17.3.0, the disclosure of which is incorporated by reference herein in its entirety. The system architecture of FIG. 1b may comprise some exemplary elements such as SCS (services capability server), AS (application server), SCEF, HSS (home subscriber server), UE, RAN (Radio Access Network), SGSN (Serving GPRS (General Packet Radio Service) Support Node), MME (Mobile Management Entity), MSC (Mobile Switching Centre), S-GW (Serving Gateway), GGSN/P-GW (Gateway GPRS Support Node/PDN (Packet Data Network) Gateway), MTC-IWF (Machine Type Communications-InterWorking Function) CDF/CGF (Charging Data Function/Charging Gateway Function), MTC-AAA (Machine Type Communications-authentication, authorization and accounting), SMS-SC/GMSC/IWMSC (Short Message Service-Service Centre/Gateway MSC/InterWorking MSC) IP-SM-GW (Internet protocol Short Message Gateway). The network elements and interfaces as shown in FIG. 1b may be same as the corresponding network elements and interfaces as described in 3GPP TS 23.682 V17.3.0.

FIG. 1c schematically shows a high level architecture in the fifth generation network according to an embodiment of the present disclosure. For example, the fifth generation network may be 5GS. The architecture of FIG. 1c is same as FIG. 4.2.3-1 of 3GPP TS 23.501 V18.0.0, the disclosure of which is incorporated by reference herein in its entirety. The system architecture of FIG. 1c may comprise some exemplary elements such as AUSF, AMF, DN (data network), NEF, NRF, NSSF, PCF, SMF, UDM, UPF, AF, UE, (R)AN, SCP (Service Communication Proxy), NSSAAF (Network Slice-Specific Authentication and Authorization Function), NSACF (Network Slice Admission Control Function), Edge Application Server Discovery Function (EASDF), etc.

In accordance with an exemplary embodiment, the UE can establish a signaling connection with the AMF over the reference point N1, as illustrated in FIG. 1c. This signaling connection may enable NAS (Non-access stratum) signaling exchange between the UE and the core network, comprising a signaling connection between the UE and the (R)AN and the N2 connection for this UE between the (R)AN and the AMF. The (R)AN can communicate with the UPF over the reference point N3. The UE can establish a protocol data unit (PDU) session to the DN (data network, e.g. an operator network or Internet) through the UPF over the reference point N6.

As further illustrated in FIG. 1c, the exemplary system architecture also contains the service-based interfaces such as Nnrf, Nnef, Nausf, Nudm, Npcf, Namf, Nnsacf, Neasdf and Nsmf exhibited by NFs such as the NRF, the NEF, the AUSF, the UDM, the PCF, the AMF, the NSACF, the EASDF and the SMF. In addition, FIG. 1c also shows some reference points such as N1, N2, N3, N4, N6 and N9, which can support the interactions between NF services in the NFs. For example, these reference points may be realized through corresponding NF service-based interfaces and by specifying some NF service consumers and providers as well as their interactions in order to perform a particular system procedure.

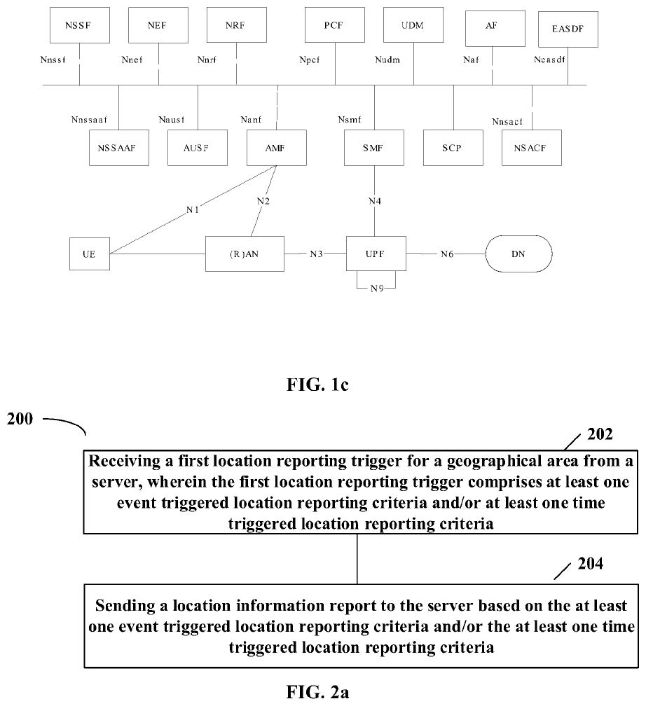

FIG. 2a shows a flowchart of a method according to an embodiment of the present disclosure, which may be performed by an apparatus implemented in or at or as a location management server or communicatively coupled to the location management server. As such, the apparatus may provide means or modules for accomplishing various parts of the method 200 as well as means or modules for accomplishing other processes in conjunction with other components.

At block 202, the location management server may receive a first location reporting trigger for a geographical area from a server. The first location reporting trigger may comprise at least one event triggered location reporting criteria and/or at least one time triggered location reporting criteria

The location management server may be any suitable node or entity or function which can implement location management function. For example, the location management server may be a functional entity that receives and stores user location information and provides user location information to another node or entity or function such as the vertical application server. The location management server may also acquire location information provided by a network operator such as Public Land Mobile Network (PLMN) operator. The location management service may optionally obtain location information from 3rd party location servers.

In an embodiment, the location management server may be the location management server as described in 3GPP TS 23.434 V18.4.0.

The geographical area may be any suitable geographical area and the present disclosure has no limit on it. For example, the geographical area may be a VAL service area as described in 3GPP TS 23.434 V18.4.0. In an embodiment, the geographical area may be served by the server. In another embodiment, the geographical area may not be served by the server. The server may have more than one service area defined. These service areas may be configured by the server to the location management server and are assigned with the unique identifier.

The server may be any suitable node or entity or function which can implement server side functionalities corresponding to applications. In an embodiment, the server may be the VAL server as described in 3GPP TS 23.434 V18.4.0. In an embodiment, the server may be the location management client as described in 3GPP TS 23.434 V18.4.0.

The first location reporting trigger may further comprise any suitable information element for triggering a location reporting procedure. For example, the first location reporting trigger may comprise the information element as described in below Table 9.3.2.4-1 of 3GPP TS 23.434 V18.4.0.

TABLE 9.3.2.4-1
Location reporting trigger

| Information element | Status | Description |
|---|---|---|
| Identity | M | Identity of the requesting authorized VAL user or |
| | (see NOTE 1) | VAL UE or VAL server |
| Identity | M | Identity of the requested VAL user or VAL UE |
| | (see NOTE 1) | |
| VAL service ID | O | Identity of the VAL service for which the location |
| | | reporting trigger is set. |
| Immediate Report Indicator | O | Indicates whether an immediate location report is |
| | (see NOTE 2) | required |
| Requested location | O | Identifies what location information is requested |
| information | (see NOTE 2) | |
| Triggering criteria | O | Identifies when the requesting client/VAL server |
| | (see NOTE 2) | is expecting to receive the location report from the |
| | | requested VAL user/VAL UE. It may include |
| | | VAL service Area ID based criteria when this |
| | | information flow is from VAL server to the |
| | | location management server. The triggering may |
| | | be e.g., SAI changes, ECGI changes, RAT |
| | | changes. |
| Minimum time between | O | Defaults to 0 if absent otherwise indicates the |
| consecutive reports | see (NOTE 2) | interval time between consecutive reports |
| Endpoint information | O | Information of the endpoint of the requesting VAL |
| | | server to which the location report notification has |
| | | to be sent. It is provided if Immediate Report |
| | | Indicator is set to required. |

(NOTE 1):
The identity of the requesting VAL user/UE/VAL server and the requested VAL user/UE should belong to the same VAL service.
(NOTE 2):
At least one of these rows shall be present.

The at least one event triggered location reporting criteria may be any suitable event triggered location reporting criteria. For example, the at least one event triggered location reporting criteria may enable to track a UE position inside and/or outside a given location (or geographical area or service area). The at least one event triggered location reporting criteria may enable flexible periodic and/or event triggered location reporting triggers with finer granularity.

The at least one time triggered location reporting criteria may be any suitable time triggered location reporting criteria. For example, the at least one time triggered location reporting criteria may enable to track a UE position inside and/or outside a given location (or geographical area or service area). The at least one time triggered location reporting criteria may enable flexible periodic and/or event triggered location reporting triggers with finer granularity.

In an embodiment, the at least one event triggered location reporting criteria may comprise at least one of a location reporting occurs when a UE moves inside a given location, a location reporting occurs when a UE moves outside a given location, a location reporting occurs when a UE stays in a given location longer than a given period of time, or a location reporting occurs when a UE stays out of a given location longer than a given period of time.

The given location may be any suitable location or service area or geographical area. For example, the given location may be same as the geographical area.

The given period of time may be any suitable period of time which can be defined in various ways. In different user cases, the given period of time may be different.

A movement of a UE may comprise any suitable movement and may be defined in various ways. For example, when the movement distance of the UE is larger than a predefined threshold, the UE may be regarded as the movement. When the movement time of the UE is larger than a predefined threshold, the UE may be regarded as the movement. When the UE moves to a specific location, the UE may be regarded as the movement.

In an embodiment, a movement of a UE may comprise at least one of a cell change of the UE, a radio access network node change of the UE, a tracking area change of the UE, a routing area change of the UE, an access network change of wireless local area network of the UE, a change of a civic address in which the UE is located, or a positioning system coordinate change of the UE.

In an embodiment, the at least one time triggered location reporting criteria may comprise at least one of a location reporting occurs with a given periodicity when a UE is inside a given location, or a location reporting occurs with a given periodicity when a UE is outside a given location.

The first location reporting trigger for the geographical area may be received in various ways and the present disclosure has no limit on it.

In an embodiment, the first location reporting trigger for the geographical area may be received from the server in a location information subscription request or a location information subscription modify request or a location area monitoring subscription request or a location area monitoring subscription modify request or during a vertical application layer server-triggered location reporting procedure.

For example, the location information subscription request may be same or similar as/to the location information subscription request as described in clause 9.3.7 of 3GPP TS 23.434 V18.4.0. For example, the first location reporting trigger for the geographical area may be received from the VAL server during a location information subscription procedure as described in clause 9.3.7 of 3GPP TS 23.434 V18.4.0.

For example, the location area monitoring subscription request may be same or similar as/to the location area monitoring subscription request as described in clause 9.3.12.1 of 3GPP TS 23.434 V18.4.0. For example, the first location reporting trigger for the geographical area may be received from the VAL server during a location area monitoring subscribe procedure as described in clause 9.3.12.1 of 3GPP TS 23.434 V18.4.0.

For example, the location area monitoring subscription modify request may be same or similar as/to the location area monitoring subscription modify request as described in clause 9.3.12.2 of 3GPP TS 23.434 V18.4.0. For example, the first location reporting trigger for the geographical area may be received from the VAL server during a location area monitoring subscribe modify procedure as described in clause 9.3.12.2 of 3GPP TS 23.434 V18.4.0.

For example, the vertical application layer server-triggered location reporting procedure may be same or similar as/to the client-triggered or VAL server-triggered location reporting procedure as described in clause 9.3.5 of 3GPP TS 23.434 V18.4.0.

In an embodiment, the first location reporting trigger for the geographical area may be received from the server in a Hyper Text Transfer Protocol (HTTP) POST request message as described in clause 5.2.1.2.2.2 of 3GPP TS 29.549 V18.1.0 or an HTTP PUT request message as described in clause 5.2.1.2.4.2 of 3GPP TS 29.549 V18.1.0 or HTTP PATCH request message as described in clause 5.2.1.2.4.2 of 3GPP TS 29.549 V18.1.0.

At block 204, the location management server may send a location information report to the server based on the at least one event triggered location reporting criteria and/or the at least one time triggered location reporting criteria.

The location information report may comprise any suitable location information. In an embodiment, the location information report may be same or similar as/to the location information report as described in below Table 9.3.2.2-1 of 3GPP TS 23.434 V18.4.0.

TABLE 9.3.2.2-1
Location information report

| Information element | Status | Description |
|---|---|---|
| Set of identities | M | Set of identities of the reporting VAL |
| | | users or VAL UEs |
| Triggering event | M | Identity of the event that triggered the |
| | | sending of the report. The triggering |
| | | event may be e.g., SAI changes, ECGI |
| | | changes, RAT changes. |
| Location | M | Location information |
| Information | | |
| Timestamp | O | Timestamp of the location report |

In an embodiment, the location information report may comprise location information of a UE.

For example, the location management server may obtain location information of a user equipment (UE) e.g. based on the at least one event triggered location reporting criteria and/or the at least one time triggered location reporting criteria. Once the location information of the UE is available in the location management server, a location information report may be sent to the server e.g. based on the at least one event triggered location reporting criteria and/or the at least one time triggered location reporting criteria.

FIG. 2b shows a flowchart of a method according to another embodiment of the present disclosure, which may be performed by an apparatus implemented in or at or as a location management server or communicatively coupled to the location management server. As such, the apparatus may provide means or modules for accomplishing various parts of the method 210 as well as means or modules for accomplishing other processes in conjunction with other components. For some parts which have been described in the above embodiments, detailed description thereof is omitted here for brevity.

At block 212, optionally, the location management server may initiate a location reporting procedure for obtaining location information of a user equipment (UE) based on the at least one event triggered location reporting criteria and/or the at least one time triggered location reporting criteria.

The location reporting procedure may be any suitable location reporting procedure as described in various 3GPP specifications such as 3GPP TS 23.434 V18.4.0.

In an embodiment, the location reporting procedure may be same or similar as/to the location reporting procedure as described in clause 9.3 of 3GPP TS 23.434 V18.4.0, such as an on-demand location reporting procedure as described in clause 9.3.4 of 3GPP TS 23.434 V18.4.0 or an event-triggered location reporting procedure as described in clause 9.3.3 of 3GPP TS 23.434 V18.4.0 or location information subscription procedure as described in clause 9.3.7 of 3GPP TS 23.434 V18.4.0.

The location management server may obtain the UE location information from the 3GPP core network and/or the 3rd party location management server and/or the UE.

At block 214, optionally, the location management server may update an old location reporting trigger for the geographical area based on the at least one event triggered location reporting criteria and/or the at least one time triggered location reporting criteria.

After updating, the location management server may perform block 204 if required.

FIGS. 2c, 2d, 2e shows three location reporting procedures for obtaining location information of the UE.

FIG. 2c shows a flowchart of a method according to another embodiment of the present disclosure, which may be performed by an apparatus implemented in or at or as a location management server or communicatively coupled to the location management server. As such, the apparatus may provide means or modules for accomplishing various parts of the method 220 as well as means or modules for accomplishing other processes in conjunction with other components. For some parts which have been described in the above embodiments, detailed description thereof is omitted here for brevity.

At block 222, the location management server may decide to immediately initiate request location information from the location management client based on the at least one event triggered location reporting criteria and/or the at least one time triggered location reporting criteria.

For example, based on the at least one event triggered location reporting criteria and/or the at least one time triggered location reporting criteria, the location management server may initiate the immediately request location information from the location management client.

At block 224, the location management server may send a location information request to the location management client.

At block 226, the location management server may receive a location information report from the location management client.

A user or UE may be notified and asked about the permission to share its location. The user can accept or deny the request. The location management client immediately responds to the location management server with a report containing location information identified by the location management server and available to the location management client.

Upon receiving the report, the location management server may update location of the reporting location management client. If the location management server does not have location information of the reporting location management client before, then just stores the reporting location information for that location management client. Then block 204 of FIG. 2a may be performed.

FIG. 2d shows a flowchart of a method according to another embodiment of the present disclosure, which may be performed by an apparatus implemented in or at or as a location management server or communicatively coupled to the location management server. As such, the apparatus may provide means or modules for accomplishing various parts of the method 230 as well as means or modules for accomplishing other processes in conjunction with other components. For some parts which have been described in the above embodiments, detailed description thereof is omitted here for brevity.

At block 232, the location management server may receive a location reporting configuration request from the location management client.

The location reporting configuration request may be used for fetching location reporting configuration.

For example, the location reporting configuration request may be same as the location reporting configuration request as described in clause 9.3.3.2 of 3GPP TS 23.434 V18.4.0.

At block 234, the location management server may generate an initial location reporting event triggers configuration or a subsequent updated location reporting event triggers configuration based on the at least one event triggered location reporting criteria and/or the at least one time triggered location reporting criteria.

For example, the initial location reporting event triggers configuration (or a subsequent update) may comprise, e.g. a location reporting occurs when a UE moves inside a given location, a location reporting occurs when a UE moves outside a given location, a location reporting occurs when a UE stays in a given location longer than a given period of time, or a location reporting occurs when a UE stays out of a given location longer than a given period of time, a location reporting occurs with a given periodicity when a UE is inside a given location, or a location reporting occurs with a given periodicity when a UE is outside a given location, minimum time between consecutive reports, Service Area Identifier (SAI) changes for reporting the location of the VAL UE, access Radio Access Technology (RAT) changes for reporting the location of the VALUE, or E-UTRAN Cell Global Identifier (ECGI) changes for reporting the location of the VAL UE.

Different location management clients may be given different location reporting criteria.

The initial location reporting event triggers configuration or a subsequent updated location reporting event triggers configuration may indicate what information the location management server expects and what events will trigger the sending of this information to the location management server. The decision to report location information can be triggered at the location management client by the initial location reporting event triggers configuration or the subsequent updated location reporting event triggers configuration.

At block 236, the location management server may send a location reporting configuration response comprising the initial location reporting event triggers configuration or the subsequent updated location reporting event triggers configuration to the location management client.

At block 238, the location management server may receive a location information report from the location management client. For example, when a location reporting event occurs, the location management server may receive a location information report from the location management client.

FIG. 2e shows a flowchart of a method according to another embodiment of the present disclosure, which may be performed by an apparatus implemented in or at or as a location management server or communicatively coupled to the location management server. As such, the apparatus may provide means or modules for accomplishing various parts of the method 240 as well as means or modules for accomplishing other processes in conjunction with other components. For some parts which have been described in the above embodiments, detailed description thereof is omitted here for brevity.

At block 242, the location management server may generate an initial location reporting event triggers configuration or a subsequent updated location reporting event triggers configuration based on the at least one event triggered location reporting criteria and/or the at least one time triggered location reporting criteria. Block 242 is same as block 234.

At block 244, the location management server may send the initial location reporting event triggers configuration or the subsequent updated location reporting event triggers configuration to the location management client.

At block 246, the location management server may receive a location information report from the location management client.

FIG. 2f shows a flowchart of a method according to another embodiment of the present disclosure, which may be performed by an apparatus implemented in or at or as a location management server or communicatively coupled to the location management server. As such, the apparatus may provide means or modules for accomplishing various parts of the method 250 as well as means or modules for accomplishing other processes in conjunction with other components. For some parts which have been described in the above embodiments, detailed description thereof is omitted here for brevity.

At block 252, the location management server may send information indicating whether the location management server supports vertical application layer service area functionality to the server.

At block 254, the location management server may receive information indicating whether the server supports vertical application layer service area functionality from the server.

For example, the location management server and the server may use feature negotiation procedures defined in 3GPP TS 29.122 V18.1.0 to negotiate the supported features, e.g., the support of vertical application layer service area functionality.

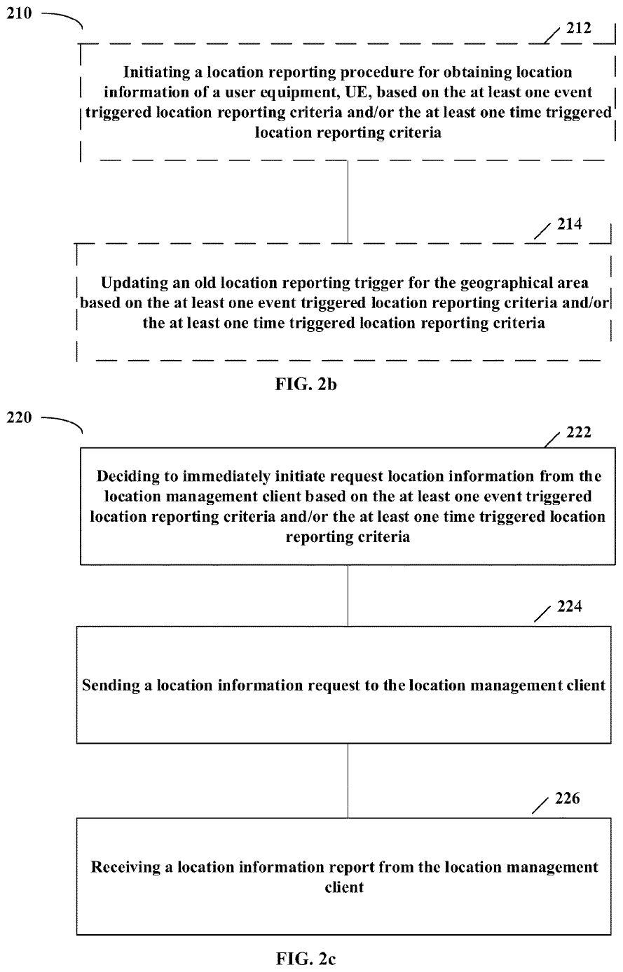

FIG. 3 shows a flowchart of a method according to another embodiment of the present disclosure, which may be performed by an apparatus implemented in or at or as a server or communicatively coupled to the server. As such, the apparatus may provide means or modules for accomplishing various parts of the method 300 as well as means or modules for accomplishing other processes in conjunction with other components. For some parts which have been described in the above embodiments, detailed description thereof is omitted here for brevity.

At block 302, the server may send a first location reporting trigger for a geographical area to a location management server. The first location reporting trigger may comprise at least one event triggered location reporting criteria and/or at least one time triggered location reporting criteria.

At block 304, the server may receive a location information report from the location management server.

In an embodiment, the at least one event triggered location reporting criteria comprises at least one of a location reporting occurs when a user equipment, UE, moves inside a given location, a location reporting occurs when a UE moves outside a given location, a location reporting occurs when a UE stays in a given location longer than a given period of time, or a location reporting occurs when a UE stays out of a given location longer than a given period of time.

In an embodiment, a movement of a UE may comprise at least one of a cell change of the UE, a radio access network node change of the UE, a tracking area change of the UE, a routing area change of the UE, an access network change of wireless local area network of the UE, a change of a civic address in which the UE is located, or a positioning system coordinate change of the UE.

In an embodiment, the at least one time triggered location reporting criteria may comprise at least one of a location reporting occurs with a given periodicity when a UE is inside a given location, or a location reporting occurs with a given periodicity when a UE is outside a given location.

In an embodiment, the first location reporting trigger for the geographical area may be sent to the location management server in a location information subscription request or a location area monitoring subscription request or a location area monitoring subscription modify request or during a vertical application layer server-triggered location reporting procedure.

In an embodiment, the server may comprise a vertical application layer server.

In an embodiment, the first location reporting trigger may be used to activate a location reporting procedure for obtaining location information of a UE, or update an old location reporting trigger for the geographical area.

In an embodiment, the location information report comprises location information of a UE.

FIG. 4 shows a flowchart of a method according to another embodiment of the present disclosure, which may be performed by an apparatus implemented in or at or as a server or communicatively coupled to the server. As such, the apparatus may provide means or modules for accomplishing various parts of the method 400 as well as means or modules for accomplishing other processes in conjunction with other components. For some parts which have been described in the above embodiments, detailed description thereof is omitted here for brevity.

At block 402, the server may receive information indicating whether the location management server supports vertical application layer service area functionality from the location management server.

At block 404, the server may send information indicating whether the server supports vertical application layer service area functionality to the location management server.

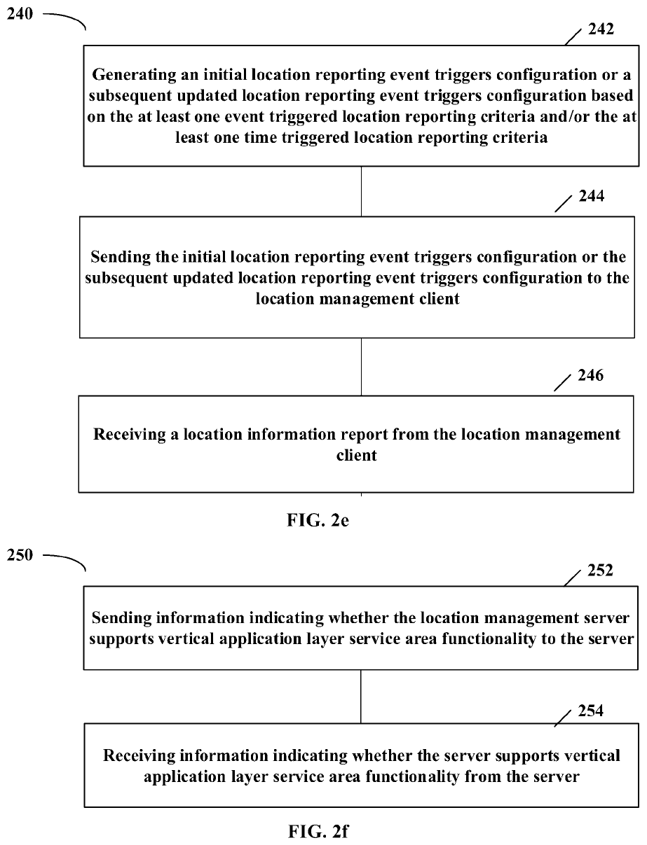

FIG. 5 shows a flowchart of a method according to another embodiment of the present disclosure, which may be performed by an apparatus implemented in or at or as a location management client or communicatively coupled to the location management client. As such, the apparatus may provide means or modules for accomplishing various parts of the method 500 as well as means or modules for accomplishing other processes in conjunction with other components. For some parts which have been described in the above embodiments, detailed description thereof is omitted here for brevity.

At block 502, the location management client may receive an initial location reporting event triggers configuration or a subsequent updated location reporting event triggers configuration from the location management server. The initial location reporting event triggers configuration or the subsequent updated location reporting event triggers configuration is generated based on at least one event triggered location reporting criteria and/or at least one time triggered location reporting criteria for a geographical area.

At block 504, the location management client may store the initial location reporting event triggers configuration or update an old location reporting event triggers configuration based on the subsequent updated location reporting event triggers configuration.

At block 506, the location management client may send a location information report to the location management server based on the initial location reporting event triggers configuration or the subsequent updated location reporting event triggers configuration.

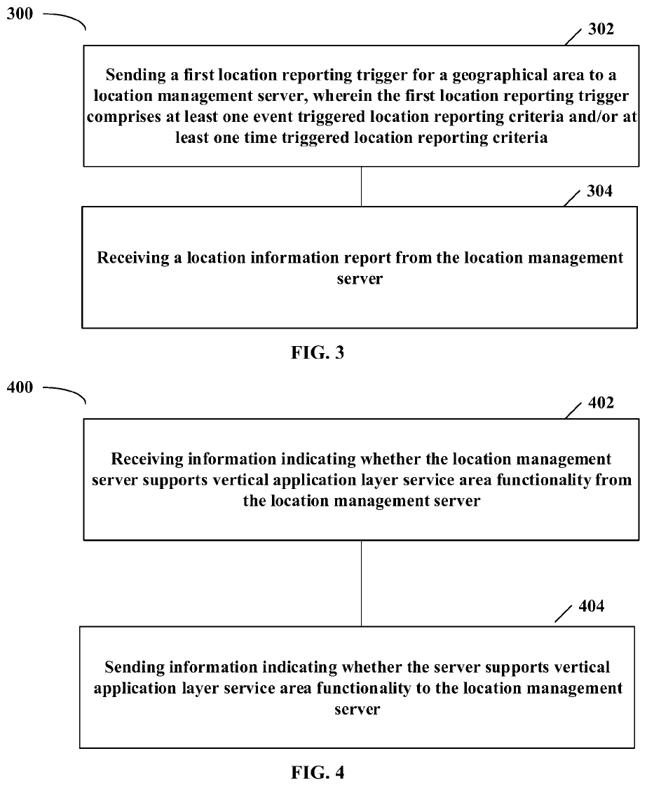

FIG. 6 shows a flowchart of a method according to another embodiment of the present disclosure, which may be performed by an apparatus implemented in or at or as a location management client or communicatively coupled to the location management client. As such, the apparatus may provide means or modules for accomplishing various parts of the method 600 as well as means or modules for accomplishing other processes in conjunction with other components. For some parts which have been described in the above embodiments, detailed description thereof is omitted here for brevity.

At block 602, the location management client may send a location reporting configuration request to a location management server.

At block 604, the location management client may receive a location reporting configuration response from the location management server.

In an embodiment, the initial location reporting event triggers configuration or the subsequent updated location reporting event triggers configuration may be received from the location management server in the location reporting configuration response.

In an embodiment, the at least one event triggered location reporting criteria may comprise at least one of a location reporting occurs when a user equipment, UE, moves inside a given location, a location reporting occurs when a UE moves outside a given location, a location reporting occurs when a UE stays in a given location longer than a given period of time, or a location reporting occurs when a UE stays out of a given location longer than a given period of time.

In an embodiment, a movement of a UE may comprise at least one of a cell change of the UE, a radio access network node change of the UE, a tracking area change of the UE, a routing area change of the UE, an access network change of wireless local area network of the UE, a change of a civic address in which the UE is located, or a positioning system coordinate change of the UE.

In an embodiment, the at least one time triggered location reporting criteria may comprise at least one of a location reporting occurs with a given periodicity when a UE is inside a given location, or a location reporting occurs with a given periodicity when a UE is outside a given location.

In an embodiment, the location information report may comprise location information of a location management client.

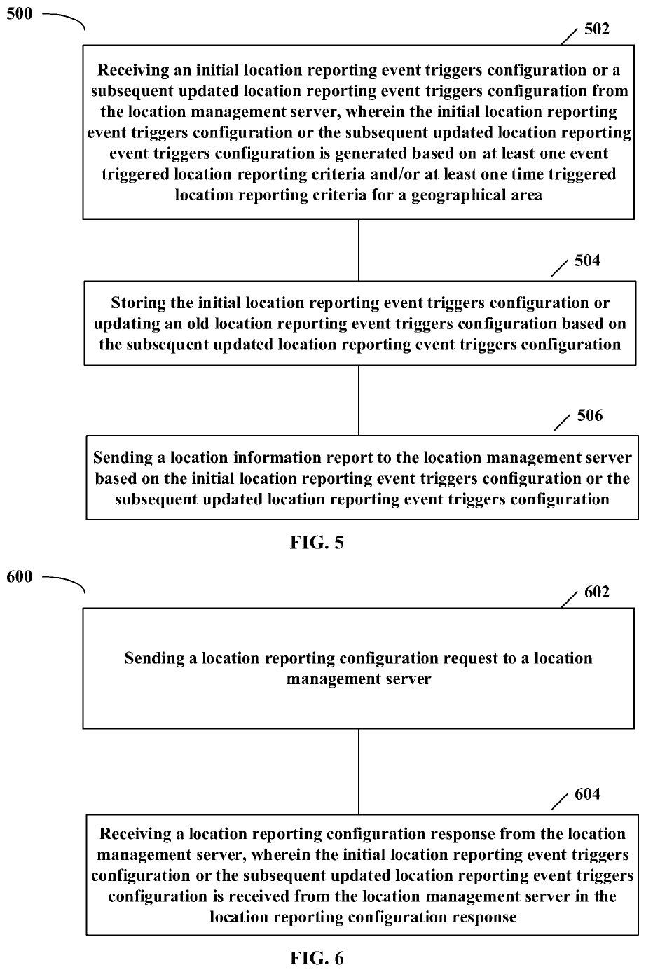

FIG. 7 shows a flowchart of a high level procedure of client-triggered or VAL server-triggered location reporting according to another embodiment of the present disclosure.

It proposes to specify the following aspects in the create location report trigger message from the VAL server to location management server: the event-triggered location reporting criteria for the VAL service area; and the periodic location reporting criteria for the VAL service area.

At step 701. Location management client 2 (authorized VAL user or VAL UE) or VAL server sends a location reporting trigger to the location management server to activate a location reporting procedure for obtaining the location information of location management client 1. The location reporting event triggers e.g. event-based and periodic conditions for the VAL service area, the at least one event triggered location reporting criteria, the at least one time triggered location reporting criteria, minimum time between consecutive reports, SAI changes, access RAT changes, or ECGI changes for reporting the location of the VAL UE, are included.

NOTE: Step 701 can be performed when Location management client 2 or VAL server require to update the location reporting trigger.

At step 702. Location management server checks whether location management client 2 or VAL server is authorized to send a location reporting trigger. Depending on the information specified by the location reporting trigger, location management server initiates an on-demand location reporting procedure or an event-triggered location reporting procedure for the location of location management client 1 based on the location reporting event triggers e.g., the at least one event triggered location reporting criteria and/or the at least one time triggered location reporting criteria.

At step 703. Once the location information of the location management client 1 is available in the location management server, a location information report is sent to the location management client 2 or VAL server based on the location reporting event triggers e.g., the at least one event triggered location reporting criteria and/or the at least one time triggered location reporting criteria.

In an embodiment, the event triggered and periodic location reporting triggering criteria are defined in the SEAL layer via the SS_LocationReporting Application Programming Interface (API) of 3GPP TS 29.549 V18.1.0. It allows to the VAL server to provide a location reporting triggering criteria for the SEAL Location Management client to the SEAL Location Management server via LM-S reference point.

In an embodiment, the event-triggered location reporting triggering criteria may comprise:
a. UE_MOVE_INSIDE: Indicates that the reporting shall occur when the UE moves inside the given location.
b. UE_MOVE_OUTSIDE: Indicates that the reporting shall occur when the UE moves outside the given location:
In an embodiment, for the UE_MOVE_INSIDE and UE_MOVE_OUTSIDE triggers, the additional location change condition may be provided:
CELL: The condition is cell change.
NODEB: The condition is eNodeB or gNodeB change.
TA_RA: The condition is TA or RA change.
WLAN_AN: The condition is WLAN access network (AN) change.
CIVIC_ADDR: The condition is civic address change.
GPS: The condition is Global Positioning System (GPS) coordinate change. Care needs to be taken with regards to load and signalling cost when using the “GPS” condition.
c. UE_STAY_IN_LOC: Indicates that the reporting shall occur when the UE stays in the given location (area) longer than a given period of time.
d. UE_STAY_OUT_LOC: Indicates that the reporting shall occur when the UE stays out of the given location longer than a given period of time.

In an embodiment, the periodic location reporting criteria may comprise:
a. PERIODIC_INSIDE_LOC: Indicates that the reporting shall occur with the given periodicity when the UE is inside the given location.
b. PERIODIC_OUTSIDE_LOC: Indicates that the reporting shall occur with the given periodicity when the UE is outside the given location.

For example, the WLAN access network change may comprise Basic Service Set Identifier (BSSID) or Service Set Identifier (SSID) change.

In an embodiment, the request from the VAL server allows to provide multiple location reporting triggers.

Compared to the existing solutions defined in 3GPP TS 29.122 V18.1.0 and 3GPP TS 29.572 V18.1.0, the proposed solution may have the benefits for the following use cases and advantages.

### Use Cases:

The VAL service area can be seen as a list of area of interest either defined as a black-list or a white-list for location change reporting, when the location reporting triggering criteria is set to UE MOVE INSIDE or UE_MOVE_OUTSIDE. It is useful in the following use cases.

Only UE location change outside forbidden zones (e.g. airport) is interested by a VAL server for drones.

Only UE location change inside a shopping mall is interested by a VAL server (for advertisement/promotion purpose) for customers or detailed football player (i.e. UE) location change (e.g. with GPS data) within a stadium in a match can be interested for statistics.

In an embodiment, it may introduce the VAL service area support and the related triggering criteria in the SS_LocationReporting API of 3GPP TS 29.549 V18.1.0.

In an embodiment, clause 7.1.1.4.1 of 3GPP TS 29.549 V18.1.0 may be amended as following.

### 7.1.1.4.1 General

This clause specifies the application data model supported by the API. Data types listed in clause 6.2 apply to this API.
Table 7.1.1.4.1-1 specifies the data types defined specifically for the SS_LocationReporting API service.

TABLE 7.1.1.4.1-1
SS_LocationReporting API specific Data Types

| Data type | Section defined | Description | Applicability |
|---|---|---|---|
| LocationReportConfiguration | 7.1.1.4.2.2 | Represents the location reporting | |
| | | configuration information. | |
| LocationReportConfigurationPatch | 7.1.1.4.2.3 | Represents the requested | PatchUpdate |
| | | modifications to the location reporting | |
| | | configuration information. | |
| | | Used to partially update Individual | |
| | | SEAL Location Reporting | |
| | | Configuration resource. | |
| LocationChangeCondition | 7.1.1.4.3.4 | Indicates the desired condition of the | SEAL3_ValSrvArea |
| | | requested location change. | |
| LocationReportEvent | 7.1.1.4.3.3 | Indicates the location-based reporting | SEAL3_ValSrvArea |
| | | trigger. | |
| LocationReportTrigger | 7.1.1.4.2.5 | Indicates the triggering criterion for | SEAL3_ValSrvArea |
| | | the location reporting. | |
| ValServiceAreaTriggeringCriteria | 7.1.1.4.2.4 | Represents the location reporting | SEAL3_ValSrvArea |
| | | triggering criteria for the given VAL | |
| | | service area ID. | |

Table 7.1.1.4.1-2 specifies data types re-used by the SS_LocationReporting API service.

TABLE 7.1.1.4.1-2
SS_LocationReporting API Re-used Data Types

| | | | |
|---|---|---|---|
| Data type | Reference | Comments | Applicability |

| | | |
|---|---|---|
| Accuracy | 3GPP TS 29.122 [3] | Used to represent the desired level of |
| | | accuracy of the requested location |
| | | information. |
| DateTime | 3GPP TS 29.571 [21] | Used to represent the subscription |
| | | duration. |
| DurationSec | 3GPP TS 29.571 [21] | Used to represent the time interval |
| | | between successive location reports. |
| SupportedFeatures | 3GPP TS 29.571 [21] | Used to negotiate the applicability of |
| | | optional features defined in |
| | | table 7.1.1.6-1. |
| ValTargetUe | Clause 7.3.1.4.2.3 | Used to indicate either VAL User ID or |
| | | VAL UE ID, to which location reporting |
| | | applies. |

In an embodiment, clause 7.1.1.4.2.2 of 3GPP TS 29.549 V18.1.0 may be amended as following.

### 7.1.1.4.2.2 Type: LocationReportConfiguration

TABLE 7.1.1.4.2.2-1
Definition of type LocationReportConfiguration

| Attribute name | Data type | P | Cardinality | Description | Applicability |
|---|---|---|---|---|---|
| valServerId | string | M | 1 | Represents the VAL server identifier. | |
| valTgtUe | ValTargetUe | M | 1 | Represents the VAL User ID or VAL UE ID | |
| | | | | to which the location reporting applies. | |
| immRep | boolean | O | 0 . . . 1 | Indication of immediate reporting. If | |
| | | | | included, when it is set to true it indicates | |
| | | | | immediate reporting of the subscribed events, | |
| | | | | if available. Otherwise, reporting will occur | |
| | | | | when the event is met. | |
| monDur | DateTime | O | 0 . . . 1 | Represents the time at which the subscription | |
| | | | | ceases to exist (i.e the reporting trigger | |
| | | | | becomes invalid). If omitted, there is no time | |
| | | | | limit. | |
| repPeriod | DurationSec | O | 0 . . . 1 | Indicates the time interval between successive | |
| | | | | location reports. (NOTE) | |
| accuracy | Accuracy | O | 0 . . . 1 | Represents the desired level of accuracy of the | |
| | | | | requested location information. (NOTE) | |
| valSrvAreaTrig | ValService | O | 0 . . . 1 | Represents the location report triggering | SEAL3_ValSrvArea |
| | AreaTriggeringCriteria | | | criteria based on the VAL service area | |
| | | | | information. | |
| suppFeat | SupportedFeatures | O | 0 . . . 1 | Used to negotiate the supported features of the | |
| | | | | API as defined in clause 7.1.1.6. | |
| | | | | This attribute shall be provided in the HTTP | |
| | | | | POST request and in the response of | |
| | | | | successful resource creation. | |

(NOTE):
This attribute is not applicable if the “SEAL3_ValSrvArea” feature is supported.

In an embodiment, clause 7.1.1.4.2.3 of 3GPP TS 29.549 V18.1.0 may be amended as following.

### 7.1.1.4.2.3 Type: LocationReportConfigurationPatch

TABLE 7.1.1.4.2.3-1
Definition of type LocationReportConfigurationPatch

| Attribute name | Data type | P | Cardinality | Description | Applicability |
|---|---|---|---|---|---|
| valTgtUe | ValTargetUe | O | 1 | Represents the VAL User ID or VAL UE ID | |
| | | | | to which the location reporting applies. | |
| monDur | DateTime | O | 0 . . . 1 | Represents the time at which the subscription | |
| | | | | ceases to exist (i.e the reporting trigger | |
| | | | | becomes invalid). If omitted, there is no time | |
| | | | | limit. | |
| repPeriod | DurationSec | O | 0 . . . 1 | Indicates the time interval between successive | |
| | | | | location reports. (NOTE) | |
| accuracy | Accuracy | O | 0 . . . 1 | Represents the desired level of accuracy of the | |
| | | | | requested location information. (NOTE) | |
| valSrvAreaTrig | ValService | O | 0 . . . 1 | Represents the location report triggering | SEAL3_ValSrvArea |
| | AreaTriggeringCriteria | | | criteria based on the VAL service area | |
| | | | | information. | |

(NOTE):
This attribute is not applicable if the “SEAL3_ValSrvArea” feature is supported.

In an embodiment, the following content may be added as clause 7.1.1.4.2.4 of 3GPP TS 29.549 V18.1.0.

### 7.1.1.4.2.4 Type: ValServiceAreaTriggeringCriteria

TABLE 7.1.1.4.2.4-1
Definition of type ValServiceAreaTriggeringCriteria

| | | | | | |
|---|---|---|---|---|---|
| Attribute name | Data type | P | Cardinality | Description | Applicability |

| | | | | |
|---|---|---|---|---|
| valSvcAreaId | string | M | 1 | Represents the VAL service area. |
| triggers | array(LocationReportTrigger) | M | 1 . . . N | Indicates the requested location reporting |
| | | | | triggers for the given VAL service area. |

Note: The cardinality of the “valSvcAreaId” attribute is FFS and to be aligned based on stage-2 requirements.

In an embodiment, the following content may be added as clause 7.1.1.4.2.5 of 3GPP TS 29.549 V18.1.0.

### 7.1.1.4.2.5 Type: LocationReportTrigger

TABLE 7.1.1.4.2.5-1
Definition of type LocationReportTrigger

| | | | | | |
|---|---|---|---|---|---|
| Attribute name | Data type | P | Cardinality | Description | Applicability |

| | | | | |
|---|---|---|---|---|
| repTrigger | LocationReportTrigger | M | 1 | Indicates the requested location reporting |
| | | | | trigger. |
| time | DurationSec | C | 0 . . . 1 | Indicates the time period for the periodic or |
| | | | | event-based location report trigger defined in |
| | | | | the “repTrigger” attribute. |
| | | | | This attribute shall be provided if the |
| | | | | “repTrigger” attribute is set to |
| | | | | “UE_STAY_IN_LOC”, |
| | | | | “UE_STAY_OUT_LOC”, |
| | | | | “PERIODIC_INSIDE_LOC”, or |
| | | | | “PERIODIC_OUTSIDE_LOC” value. |
| locChgCond | LocationChangeCondition | C | 0 . . . 1 | Indicates the reporting condition for the |
| | | | | event-based location report trigger defined in |
| | | | | the “repTrigger” attribute. |
| | | | | This attribute shall be provided if the |
| | | | | “repTrigger” attribute is set to |
| | | | | “UE_MOVE_INSIDE” or |
| | | | | “UE_MOVE_OUTSIDE” value. |

In an embodiment, the following content may be added as clause 7.1.1.4.3.1 of 3GPP TS 29.549 V18.1.0.

### 7.1.1.4.3.1 Introduction

This clause defines simple data types and enumerations that are referenced from data structures defined in the previous clauses. In addition, data types and enumerations defined in clause 6.2.1 can be referenced.

In an embodiment, the following content may be added as clause 7.1.1.4.3.2 of 3GPP TS 29.549 V18.1.0.

### 7.1.1.4.3.2 Simple Data Types

The simple data types defined in table 7.1.1.4.3.2-1 shall be supported.

TABLE 7.1.1.4.3.2-1
Simple data types

| | |
|---|---|
| Type name | Description |

In an embodiment, the following content may be added as clause 7.1.1.4.3.3 of 3GPP TS 29.549 V18.1.0.

### 7.1.1.4.3.3 Enumeration: LocationReportEvent

TABLE 7.1.1.4.3.3-1
Enumeration LocationReportEvent

| | | |
|---|---|---|
| Enumeration value | Description | Applicability |

| | |
|---|---|
| UE_STAY_IN_LOC | Indicates that the reporting shall occur when the UE |
| | stays in the given location longer than a given |
| | period of time. |
| UE_STAY_OUT_LOC | Indicates that the reporting shall occur when the UE |
| | stays out of the given location longer than a given |
| | period of time. |
| PERIODIC_INSIDE_LOC | Indicates that the reporting shall occur with the |
| | given periodicity when the UE is inside the given |
| | location. |
| PERIODIC_OUTSIDE_LOC | Indicates that the reporting shall occur with the |
| | given periodicity when the UE is outside the given |
| | location. |
| UE_MOVE_INSIDE | Indicates that the reporting shall occur when the UE |
| | moves inside the location with the given |
| | event-based reporting condition. |
| UE_MOVE_OUTSIDE | Indicates that the reporting shall occur when the UE |
| | moves outside the given location with the given |
| | event-based reporting condition. |

In an embodiment, the following content may be added as clause 7.1.1.4.3.4 of 3GPP TS 29.549 V18.1.0.

### 7.1.1.4.3.4 Enumeration: LocationChangeCondition

The enumeration LocationChangeCondition represents a desired condition of the requested location change. It shall comply with the provisions defined in table 7.1.1.4.3.4-1.

TABLE 7.1.1.4.3.4-1
Enumeration LocationChangeCondition

| | | |
|---|---|---|
| Enumeration | | |
| value | Description | Applicability |

| | |
|---|---|
| CELL | The condition is cell change. |
| NODEB | The condition is eNodeB or gNodeB change. |
| TA_RA | The condition is TA or RA change. |
| WLAN_AN | The condition is WLAN access network change, e.g. BSSID or SSID change. |
| CIVIC_ADDR | The condition is civic address change. |
| GPS | The condition is GPS coordinate change. (NOTE) |

NOTE:
Care needs to be taken with regards to load and signalling cost when using the “GPS” condition.

In an embodiment, clause 7.1.1.6 of 3GPP TS 29.549 V18.1.0 may be amended as following.

7.1.1.6 Feature Negotiation General feature negotiation procedures are defined in clause 6.8.

TABLE 7.1.1.6-1
Supported Features

| Feature | | |
|---|---|---|
| number | Feature Name | Description |
| 1 | PatchUpdate | Indicates the support of the PATCH |
| | | method for updating an Individual |
| | | SEAL Location Reporting |
| | | Configuration resource. |
| 2 | SEAL3_ValSrvArea | Indicates the support of the VAL |
| | | service area functionality. |

The various blocks shown in figures may be viewed as method steps, and/or as operations that result from operation of computer program code, and/or as a plurality of coupled logic circuit elements constructed to carry out the associated function(s). The schematic flow chart diagrams described above are generally set forth as logical flow chart diagrams. As such, the depicted order and labeled steps are indicative of specific embodiments of the presented methods. Other steps and methods may be conceived that are equivalent in function, logic, or effect to one or more steps, or portions thereof, of the illustrated methods. Additionally, the order in which a particular method occurs may or may not strictly adhere to the order of the corresponding steps shown.

Embodiments herein afford many advantages, of which a non-exhaustive list of examples follows. In some embodiments herein, the proposed solution can allow to track UE position inside and/or outside the given location. The solution in 3GPP TS 29.572 V18.1.0 (see enumeration: LdrType) allows to track UEs inside the location only. In some embodiments herein, the proposed solution can enable flexible periodic and/or event triggered location reporting triggers with finer granularity. For example, the reporting may occur if UE stays inside/outside the given location longer than the given time period. The UE staying inside/outside an area for a period of time is useful to eliminate the situation when UE is travelling across the border of the area with frequent “in” and “out” report (build in hysteresis support). In some embodiments herein, the tracking (a sequence of the location reports) may occur when UE moves inside/outside the given location with the given granularity based on the provided location change condition (e.g., CELL/ENb/etc. change or GPS coordinate change). In some embodiments herein, the UE position may be tracked based on the GPS coordinate changed event when UE moves outside the given location. In some embodiments herein, the proposed solution enables the flexible tracking of the UE position in 3GPP system. The embodiments herein are not limited to the features and advantages mentioned above. A person skilled in the art will recognize additional features and advantages upon reading the following detailed description.

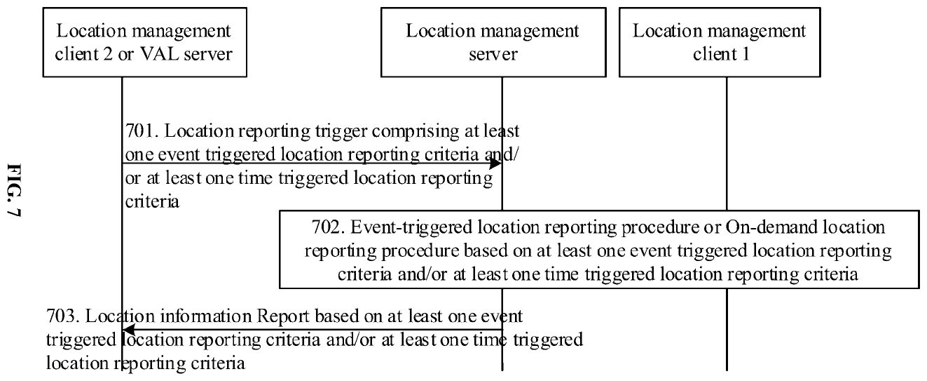

FIG. 8a is a block diagram showing an apparatus suitable for practicing some embodiments of the disclosure. For example, the location management server, the server or the location management client described above may be implemented as or through the apparatus 800.

The apparatus 800 may comprise at least one processor 821, such as a digital processor (DP), and at least one memory (MEM) 822 coupled to the processor 821. The apparatus 800 may further comprise a transmitter TX and receiver RX 823 coupled to the processor 821. The MEM 822 stores a program (PROG) 824. The PROG 824 may include instructions that, when executed on the associated processor 821, enable the apparatus 800 to operate in accordance with the embodiments of the present disclosure. A combination of the at least one processor 821 and the at least one MEM 822 may form processing means 825 adapted to implement various embodiments of the present disclosure.

Various embodiments of the present disclosure may be implemented by computer program executable by one or more of the processor 821, software, firmware, hardware or in a combination thereof.

The MEM 822 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 821 may be of any type suitable to the local technical environment, and may include one or more of general purpose computers, special purpose computers, microprocessors, digital signal processors (DSPs) and processors based on multicore processor architecture, as non-limiting examples.

In an embodiment where the apparatus is implemented as or at the location management server, the memory 822 contains instructions executable by the processor 821, whereby the location management server operates according to any of the methods performed by the location management server as described above.

In an embodiment where the apparatus is implemented as or at the server, the memory 822 contains instructions executable by the processor 821, whereby the server operates according to any of the methods performed by the server as described above.

In an embodiment where the apparatus is implemented as or at the location management client, the memory 822 contains instructions executable by the processor 821, whereby the location management client operates according to any of the methods performed by the location management client as described above.

FIG. 8b is a block diagram showing a location management server according to an embodiment of the disclosure. As shown, the location management server 850 may comprise a first receiving module 851 configured to receive a first location reporting trigger for a geographical area from a server. The first location reporting trigger comprises at least one event triggered location reporting criteria and/or at least one time triggered location reporting criteria. The location management server 850 may comprise a first sending module 852 configured to send a location information report to the server based on the at least one event triggered location reporting criteria and/or the at least one time triggered location reporting criteria.

In an embodiment, the location management server 850 may further comprise an initiating module 853 configured to initiate a location reporting procedure for obtaining location information of a user equipment (UE) based on the at least one event triggered location reporting criteria and/or the at least one time triggered location reporting criteria.

In an embodiment, the location management server 850 may further comprise an updating module 854 configured to update an old location reporting trigger for the geographical area based on the at least one event triggered location reporting criteria and/or the at least one time triggered location reporting criteria.

In an embodiment, the location management server 850 may further comprise a second sending module 855 configured to send information indicating whether the location management server supports vertical application layer service area functionality to the server.

In an embodiment, the location management server 850 may further comprise a second receiving module 856 configured to receive information indicating whether the server supports vertical application layer service area functionality from the server.

FIG. 8c is a block diagram showing a server according to an embodiment of the disclosure. As shown, the server 860 may comprise a first sending module 861 configured to send a first location reporting trigger for a geographical area to a location management server. The first location reporting trigger comprises at least one event triggered location reporting criteria and/or at least one time triggered location reporting criteria. The server 860 may further comprise a first receiving module 862 configured to receive a location information report from the location management server.

In an embodiment, the server 860 may comprise a second receiving module 863 configured to receive information indicating whether the location management server supports vertical application layer service area functionality from the location management server.

In an embodiment, the server 860 may comprise a second sending module 864 configured to send information indicating whether the server supports vertical application layer service area functionality to the location management server.

FIG. 8d is a block diagram showing a location management client according to an embodiment of the disclosure. As shown, the location management client 880 may comprise a first receiving module 881 configured to receive an initial location reporting event triggers configuration or a subsequent updated location reporting event triggers configuration from the location management server. The initial location reporting event triggers configuration or the subsequent updated location reporting event triggers configuration may be generated based on at least one event triggered location reporting criteria and/or at least one time triggered location reporting criteria for a geographical area. The location management client 880 may further comprise a storing module 882 configured to store the initial location reporting event triggers configuration or updating an old location reporting event triggers configuration based on the subsequent updated location reporting event triggers configuration. The location management client 880 may further comprise a first sending module 883 configured to send a location information report to the location management server based on the initial location reporting event triggers configuration or the subsequent updated location reporting event triggers configuration.

In an embodiment, the location management client 880 may further comprise a second sending module 884 configured to send a location reporting configuration request to a location management server.

In an embodiment, the location management client 880 may further comprise a second receiving module 885 configured to receive a location reporting configuration response from the location management server. The initial location reporting event triggers configuration or the subsequent updated location reporting event triggers configuration may be received from the location management server in the location reporting configuration response.

The term unit or module may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With function units, the location management server, the server or the location management client may not need a fixed processor or memory, any computing resource and storage resource may be arranged from the location management server, the server or the location management client in the communication system. The introduction of virtualization technology and network computing technology may improve the usage efficiency of the network resources and the flexibility of the network.

Further, the exemplary overall commutation system including the terminal device (such as the location management client) and the network node (such as the location management server or the server) will be introduced as below.

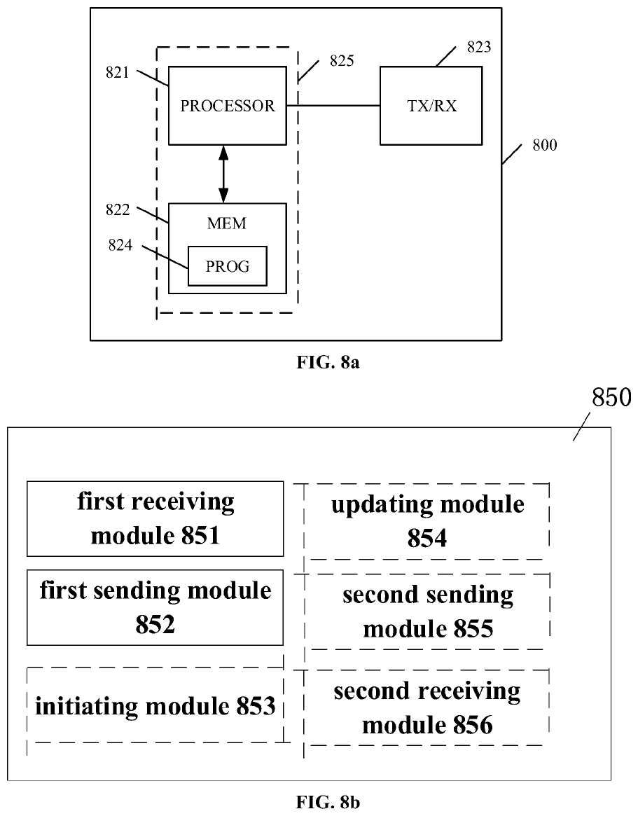

FIG. 9 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3rd Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network QQ102 includes one or more Open-RAN (ORAN) network nodes. An ORAN network node is a node in the telecommunication network QQ102 that supports an ORAN specification (e.g., a specification published by the O-RAN Alliance, or any similar organization) and may operate alone or together with other nodes to implement one or more functionalities of any node in the telecommunication network QQ102, including one or more network nodes QQ110 and/or core network nodes QQ108.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

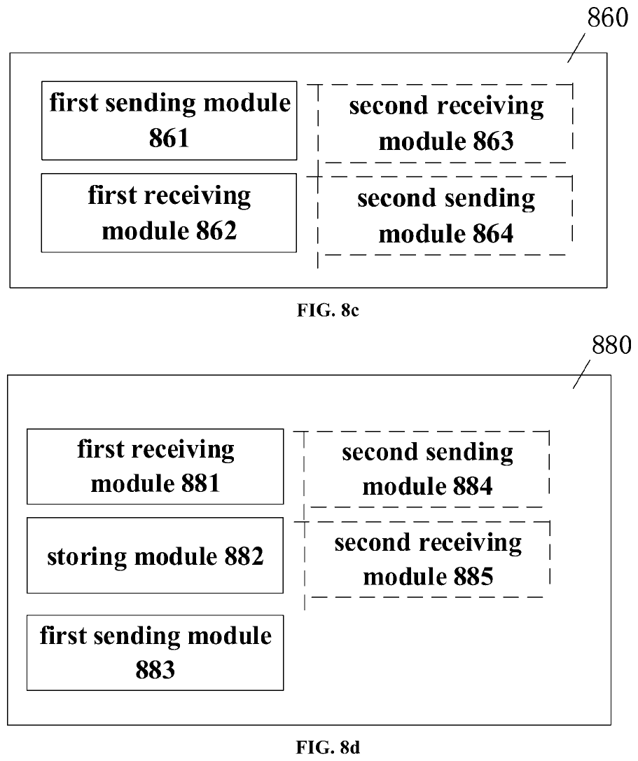

FIG. 10 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. 10.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

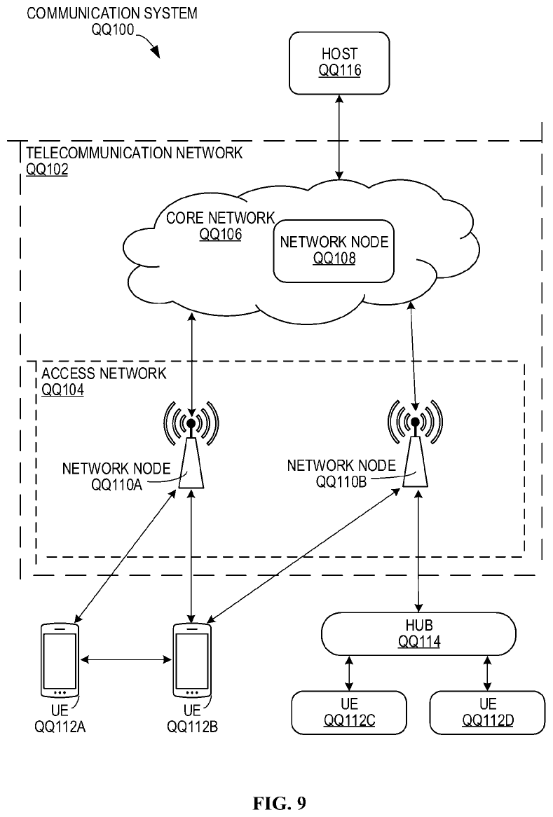

FIG. 11 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 11 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

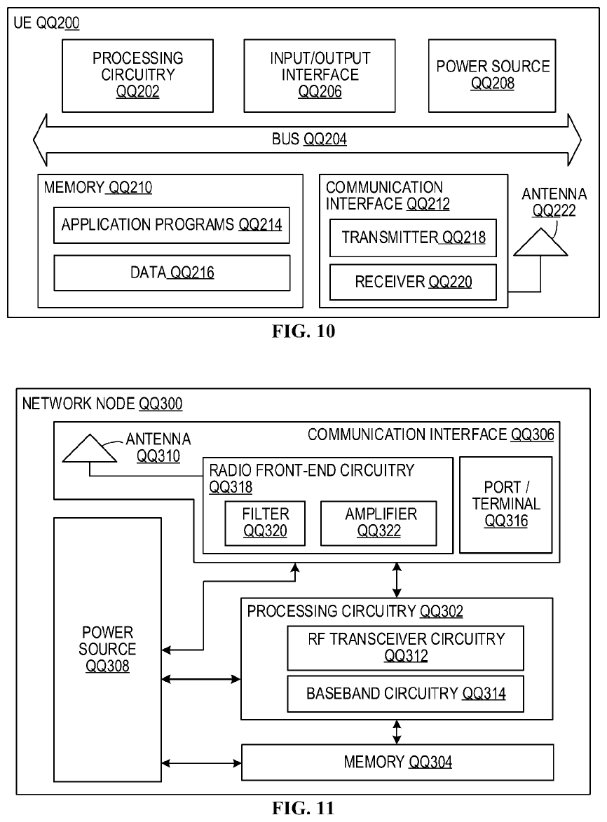

FIG. 12 is a block diagram of a host QQ400, which may be an embodiment of the host QQ116 of FIG. 9, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the terminal devices, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

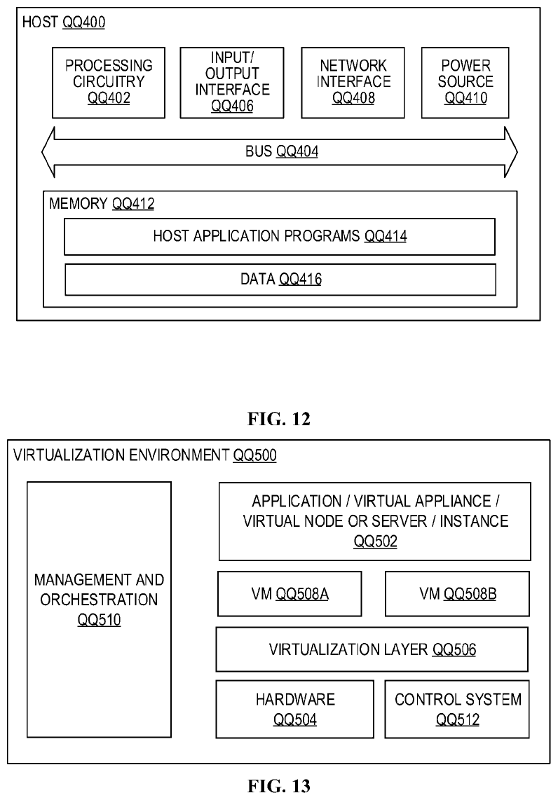

FIG. 13 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment QQ500 includes components defined by the O-RAN Alliance, such as an O-Cloud environment orchestrated by a Service Management and Orchestration Framework via an O-2 interface.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508A and QQ508B (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

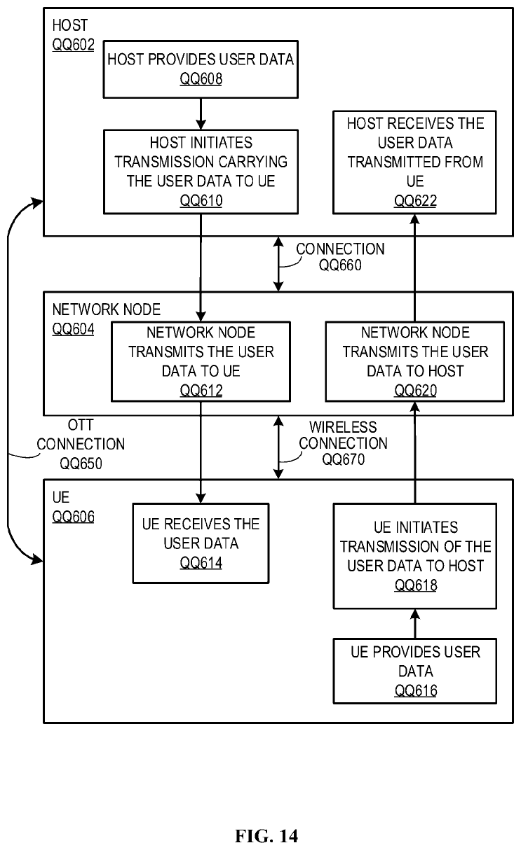

FIG. 14 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 9), network node (such as network node QQ110a of FIG. 9), and host (such as host QQ116 of FIG. 9 and/or host QQ400 of FIG. 12) discussed in the preceding paragraphs will now be described with reference to FIG. 14.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 9) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, in some embodiments herein, the proposed solution can allow to track UE position inside and/or outside the given location. In some embodiments herein, the proposed solution can enable flexible periodic and/or event triggered location reporting triggers with finer granularity. In some embodiments herein, the tracking (a sequence of the location reports) may occur when UE moves inside/outside the given location with the given granularity based on the provided location change condition. In some embodiments herein, the UE position may be tracked based on the GPS coordinate changed event when UE moves outside the given location. In some embodiments herein, the proposed solution enables the flexible tracking of the UE position in 3GPP system.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Embodiment 1. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform any of the operations related to the network node as described above to transmit the user data from the host to the UE.

Embodiment 2. The host of the previous embodiment, wherein:
the processing circuitry of the host is configured to execute a host application that provides the user data; and
the UE comprises processing circuitry configured to execute a client application associated with the host application to receive the transmission of user data from the host.

Embodiment 3. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs the operations related to the network node as described above to transmit the user data from the host to the UE.

Embodiment 4. The method of the previous embodiment, further comprising, at the network node, transmitting the user data provided by the host for the UE.

Embodiment 5. The method of any of the previous 2 embodiments, wherein the user data is provided at the host by executing a host application that interacts with a client application executing on the UE, the client application being associated with the host application.

Embodiment 6. A communication system configured to provide an over-the-top (OTT) service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform any of the operations related to the network node as described above to transmit the user data from the host to the UE.

Embodiment 7. The communication system of the previous embodiment, further comprising:
the network node; and/or
the user equipment.

Embodiment 8. The communication system of the previous 2 embodiments, wherein:
the processing circuitry of the host is configured to execute a host application, thereby providing the user data; and
the host application is configured to interact with a client application executing on the UE, the client application being associated with the host application.

Embodiment 9. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform any of the operations related to the network node as described above to receive the user data from the UE for the host.

Embodiment 10. The host of the previous 2 embodiments, wherein:
the processing circuitry of the host is configured to execute a host application, thereby providing the user data; and
the host application is configured to interact with a client application executing on the UE, the client application being associated with the host application.

Embodiment 11. The host of they of the previous 2 embodiments, wherein the initiating receipt of the user data comprises requesting the user data.

Embodiment 12. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs the operations related to the network node as described above to receive the user data from the UE for the host.

Embodiment 13. The method of the previous embodiment, further comprising at the network node, transmitting the received user data to the host.

Embodiment 14. A host configured to operate in a communication system to provide an over-the-top (OTT) service, the host comprising:
processing circuitry configured to provide user data; and
a network interface configured to initiate transmission of the user data to a cellular network for transmission to a user equipment (UE), wherein the UE comprises a communication interface and processing circuitry, the communication interface and processing circuitry of the UE being configured to perform any of the operations related to the UE as described above to receive the user data from the host.

Embodiment 15. The host of the previous embodiment, wherein the cellular network further includes a network node configured to communicate with the UE to transmit the user data to the UE from the host.

Embodiment 16. The host of the previous 2 embodiments, wherein:
the processing circuitry of the host is configured to execute a host application, thereby providing the user data; and
the host application is configured to interact with a client application executing on the UE, the client application being associated with the host application.

Embodiment 17. A method implemented by a host operating in a communication system that further includes a network node and a user equipment (UE), the method comprising: providing user data for the UE; and
initiating a transmission carrying the user data to the UE via a cellular network comprising the network node, wherein the UE performs any of the operations related to the UE as described above to receive the user data from the host.

Embodiment 18. The method of the previous embodiment, further comprising:
at the host, executing a host application associated with a client application executing on the UE to receive the user data from the UE.

Embodiment 19. The method of the previous embodiment, further comprising:
at the host, transmitting input data to the client application executing on the UE, the input data being provided by executing the host application,
wherein the user data is provided by the client application in response to the input data from the host application.

Embodiment 20. A host configured to operate in a communication system to provide an over-the-top (OTT) service, the host comprising:
processing circuitry configured to utilize user data; and
a network interface configured to receipt of transmission of the user data to a cellular network for transmission to a user equipment (UE),
wherein the UE comprises a communication interface and processing circuitry, the communication interface and processing circuitry of the UE being configured to perform any of the operations related to the UE as described above to transmit the user data to the host.

Embodiment 21. The host of the previous embodiment, wherein the cellular network further includes a network node configured to communicate with the UE to transmit the user data from the UE to the host.

Embodiment 22. The host of the previous 2 embodiments, wherein:
the processing circuitry of the host is configured to execute a host application, thereby providing the user data; and
the host application is configured to interact with a client application executing on the UE, the client application being associated with the host application.

Embodiment 23. A method implemented by a host configured to operate in a communication system that further includes a network node and a user equipment (UE), the method comprising:
at the host, receiving user data transmitted to the host via the network node by the UE, wherein the UE performs any of the operations related to the UE as described above to transmit the user data to the host.

Embodiment 24. The method of the previous embodiment, further comprising:
at the host, executing a host application associated with a client application executing on the UE to receive the user data from the UE.

Embodiment 25. The method of the previous embodiments, further comprising:
at the host, transmitting input data to the client application executing on the UE, the input data being provided by executing the host application,
wherein the user data is provided by the client application in response to the input data from the host application.

The term unit or module may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

According to an aspect of the disclosure it is provided a computer program product being tangibly stored on a computer readable storage medium and including instructions which, when executed on at least one processor, cause the at least one processor to carry out any of the methods as described above.

According to an aspect of the disclosure it is provided a computer-readable storage medium storing instructions which when executed by at least one processor, cause the at least one processor to carry out any of the methods as described above.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1.-35. (canceled)

36. A method performed by a location management server, comprising:
receiving a first location reporting trigger for a geographical area from a server, wherein the first location reporting trigger comprises the geographical area and location reporting criteria associated with whether a user equipment (UE) with a location management client is inside or outside a given location, wherein the location reporting criteria comprise one or more of the following:
event triggered location reporting criteria, and
time triggered location reporting criteria; and
sending a location information report to the server based on the location reporting criteria.

37. The method according to claim 36, further comprising:
initiating a location reporting procedure for obtaining location information of the UE based on the location reporting criteria; and/or
updating an old location reporting trigger for the geographical area based on the location reporting criteria.

38. The method according to claim 37, wherein the method comprises said initiating, wherein the initiating the location reporting procedure for obtaining location information of the UE based on the location reporting criteria comprises:
deciding to immediately initiate a request for location information from the location management client based on the location reporting criteria;
sending a location information request to the location management client; and
receiving a location information report from the location management client.

39. The method according to claim 37, wherein the method comprises said initiating, wherein the initiating the location reporting procedure for obtaining location information of the UE based on the location reporting criteria comprises:
receiving a location reporting configuration request from the location management client;
generating an initial location reporting configuration or a subsequent updated location reporting configuration based on the location reporting criteria;
sending a location reporting configuration response comprising the initial location reporting configuration or the subsequent updated location reporting configuration to the location management client; and
receiving a location information report from the location management client.

40. The method according to claim 36, wherein the event triggered location reporting criteria comprise at least one of:
a location reporting occurs when the UE moves inside the given location,
a location reporting occurs when the UE moves outside the given location,
a location reporting occurs when the UE stays in the given location longer than a given period of time, or
a location reporting occurs when the UE stays out of the given location longer than a given period of time.

41. The method according to claim 40, wherein a movement of the UE comprises at least one of:
a cell change of the UE,
a radio access network node change of the UE,
a tracking area change of the UE,
a routing area change of the UE,
an access network change of wireless local area network of the UE,
a change of a civic address in which the UE is located, or
a positioning system coordinate change of the UE.

42. The method according to claim 36, wherein the time triggered location reporting criteria comprise at least one of:
a location reporting occurs with a given periodicity when the UE is inside the given location, or
a location reporting occurs with a given periodicity when the UE is outside the given location.

43. The method according to claim 36, wherein the first location reporting trigger for the geographical area is received from the server in a location information subscription request or a location area monitoring subscription request or a location area monitoring subscription modify request or during a vertical application layer server-triggered location reporting procedure.

44. The method according to claim 36, further comprising:
sending information indicating whether the location management server supports vertical application layer service area functionality to the server; and
receiving information indicating whether the server supports vertical application layer service area functionality from the server.

45. A method performed by a server, comprising:
sending a first location reporting trigger for a geographical area to a location management server, wherein the first location reporting trigger comprises the geographical area and location reporting criteria associated with whether a user equipment (UE) with a location management client is inside or outside a given location, wherein the location reporting criteria comprise one or more of the following:
event triggered location reporting criteria, and
time triggered location reporting criteria; and
receiving a location information report from the location management server.

46. The method according to claim 45, wherein the event triggered location reporting criteria comprise at least one of:
a location reporting occurs when the UE moves inside the given location,
a location reporting occurs when the UE moves outside the given location,
a location reporting occurs when the UE stays in the given location longer than a given period of time, or
a location reporting occurs when the UE stays out of the given location longer than a given period of time.

47. The method according to claim 46, wherein a movement of the UE comprises at least one of:
a cell change of the UE,
a radio access network node change of the UE,
a tracking area change of the UE,
a routing area change of the UE,
an access network change of wireless local area network of the UE,
a change of a civic address in which the UE is located, or
a positioning system coordinate change of the UE.

48. The method according to claim 45, wherein the time triggered location reporting criteria comprise at least one of:
a location reporting occurs with a given periodicity when a UE is inside the given location, or
a location reporting occurs with a given periodicity when the UE is outside the given location.

49. The method according to claim 45, further comprising:
receiving information indicating whether the location management server supports vertical application layer service area functionality from the location management server; and
sending information indicating whether the server supports vertical application layer service area functionality to the location management server.

50. A method performed by a location management client, comprising:
Receiving, at a Service Enabler Architecture Layer for Verticals (SEAL) protocol layer, an initial location reporting configuration or a subsequent updated location reporting configuration from the location management server, wherein the initial location reporting configuration or the subsequent updated location reporting configuration comprises a geographical area and location reporting criteria associated with whether a user equipment (UE) with the location management client is inside or outside a given location, wherein the location reporting criteria comprise one or more of the following:
event triggered location reporting criteria, and
time triggered location reporting criteria;
storing the initial location reporting configuration or updating an old location reporting configuration based on the subsequent updated location reporting configuration; and
sending, at the SEAL protocol layer, a location information report to the location management server based on the initial location reporting configuration or the subsequent updated location reporting configuration.

51. The method according to claim 50, further comprising:
sending a location reporting configuration request to a location management server; and
receiving a location reporting configuration response from the location management server,
wherein the initial location reporting configuration or the subsequent updated location reporting configuration is received from the location management server in the location reporting configuration response.

52. The method according to claim 50, wherein the event triggered location reporting criteria comprise at least one of:
a location reporting occurs when the UE moves inside the given location,
a location reporting occurs when the UE moves outside the given location,
a location reporting occurs when the UE stays in the given location longer than a given period of time, or
a location reporting occurs when the UE stays out of the given location longer than a given period of time.

53. The method according to claim 52, wherein a movement of the UE comprises at least one of:
a cell change of the UE,
a radio access network node change of the UE,
a tracking area change of the UE,
a routing area change of the UE,
an access network change of wireless local area network of the UE,
a change of a civic address in which the UE is located, or
a positioning system coordinate change of the UE.

54. The method according to claim 50, wherein the time triggered location reporting criteria comprise at least one of:
a location reporting occurs with a given periodicity when the UE is inside the given location, or
a location reporting occurs with a given periodicity when the UE is outside the given location.

55. A location management server, comprising:
a processor; and
a memory coupled to the processor, said memory containing instructions executable by said processor, whereby said location management server is operative to
receive a first location reporting trigger for a geographical area from a server,
wherein the first location reporting trigger comprises the geographical area and location reporting criteria associated with whether a user equipment (UE) with a location management client is inside or outside a given location, wherein the location reporting criteria comprise one or more of the following:
event triggered location reporting criteria, and
time triggered location reporting criteria; and
send a location information report to the server based on the location reporting criteria.

56. A location management client, comprising:
a processor; and
a memory coupled to the processor, said memory containing instructions executable by said processor, whereby said location management client is operative to
receive at a Service Enabler Architecture Layer for Verticals (SEAL) protocol layer an initial location reporting configuration or a subsequent updated location reporting configuration from the location management server, wherein the initial location reporting configuration or the subsequent updated location reporting configuration comprises a geographical area and location reporting criteria associated with whether a user equipment (UE) with the location management client is inside or outside a given location, wherein the location reporting criteria comprise one or more of the following:
event triggered location reporting criteria, and
time triggered location reporting criteria;
store the initial location reporting configuration or updating an old location reporting configuration based on the subsequent updated location reporting configuration; and
send at the SEAL protocol layer a location information report to the location management server based on the initial location reporting configuration or the subsequent updated location reporting configuration.
